(19) United States
(12) Patent Application Publication
(10) Pub. No.: US 2008/0218480 A1
(43) Pub. Date: Sep. 11, 2008

(54) Display and Keypad Assembly and Mobile Telephone That Includes Said Assembly

(76) Inventor: Jordi Badia I Farre, Barcelona (ES)

Correspondence Address: GOTTLIEB RACKMAN & REISMAN PC, 270 MADISON AVENUE, 8TH FLOOR, NEW YORK, NY, 10016-0601, US

(21) Appl. No.: 11/813,100

(22) PCT Filed: Dec. 20, 2005
(86) PCT No.: PCT/IB2005/003984

§ 371 Date: Jun. 29, 2007

(30) Foreign Application Priority Data
Dec. 31, 2004 (ES) P-200403167

(51) Int. Cl. G06F 3/02

(52) U.S. Cl. 345/168

(57) ABSTRACT

Assembly suitable for applying to appliances that are used with one hand, which includes a casing (2), and is characterised in that the display (3) is mounted on the upper side (2a) of said casing (2) and the keypad (4) on the lower side (2b) thereof, with said keypad (4) including at least three keys (4a), actuatable in a plurality of directions in order for each of them to enter a plurality of characters (5), and mobile telephone that includes the keypad (4) and display (3) assembly claimed. It permits characters to be obtained on the display without needing to look at the keypad.

The present invention relates to a display and keypad assembly suitable for application on appliances that are used with one hand, particularly for mobile telephones, and to a mobile telephone that includes said display and keypad assembly.

### BACKGROUND OF THE INVENTION

Mobile telephones are known that include a keypad and a display mounted in the front side of the casing of said telephone, in such a way that the keypad occupies the lower half of the surface of said side, while the display occupies the upper half of the same side.

The dimensions of the casings of such mobile telephones have been reduced considerably in order to provide compact appliances that are convenient and easy to carry. The constant increase in the number of functions that such mobile phones carry out nevertheless calls for large displays, which has redounded negatively on the size of keypads, which have become ever smaller, making it hard to see the characters, and making actual use of the appliance more difficult for the majority of users, and particularly for more elderly persons.

The keypad of such mobile telephones presents at least ten keys that can be actuated in a single direction and are inscribed with the numbers from “0” to “9”, and the letters of the alphabet. In order to enter a numerical character any of said ten keys has to be pressed once only, while to enter a letter the keys have to be pressed successively from one to four times, with the time interval between each key-press being lower than a predetermined value.

Said keypad has the disadvantage of being impractical to use, especially for writing text messages, as having to press several keys successively in order to enter the letters makes writing very slow, so that it is necessary to look at the display continuously in order ensure that the letter displayed is the one chosen and in order to avoid errors.

### DESCRIPTION OF THE INVENTION

The objective of this invention is to resolve the disadvantages mentioned, by developing a display and keypad assembly having the advantages that will be set out below.

In accordance with this objective, a first aspect of this invention is to provide a display and keypad assembly suitable for applying to appliances that are used with one hand and that includes a casing, and is characterised in that the display is mounted on the upper side of said casing and the keypad on the lower side thereof, with said keypad including at least three keys, actuatable in a plurality of directions in order for each of them to enter a plurality of characters.

Thanks to these characteristics, the display and keypad assembly of this invention presents the following advantages:

It is possible to use the keypad without looking at it, since the fact that said keypad has very many fewer keys than those of the state of the art means that both the position and the meaning of the characters inscribed on them is easy for the user to remember. The size of the keys can also be larger, which makes them also easier to locate and use, even without looking at the keypad.

The dimensions of the display are not conditioned by the presence of an adjacent keypad, and said display can occupy the entire area of the upper side of the casing, making it easier to display all kinds of characters and pictures on it.

The keypad is very easy and fast to use, since the fact that the keys are actuated in multiple directions means that many characters can be entered with a single actuation of said keys. Furthermore, as noted, said keys can be of larger size, so that the characters inscribed on them are easy to recognise.

Preferably, said keypad includes six keys with multidirectional actuation. This number has the advantage of still remaining very much lower than the number of keys found on the assemblies of the state of the art, while at the same time it enables most of the characters to be assigned a specific spatial layout on each one of the keys, so that the characters can be entered with a single key-press or key-actuation in the appropriate direction. This makes the keypad all the easier to remember, and more practical and convenient to use.

Also preferably, said six keys are arranged in an orderly way into rows and columns forming a matrix, with each of said keys being inscribed with a group of characters, with said characters arranged spatially on each of said keys, and said groups within the matrix assembly, in such a way that they are easy for the user of said appliance to remember.

Advantageously, said matrix presents two rows and three columns, and said group includes at least one numerical character and at least four characters in alphabetical order.

The layout of the six keys in matrix form, and especially in two rows and three columns, is the optimum layout to facilitate rapid user recognition, even without looking at them, of the position and meaning of the characters inscribed on the keypad, since it is very easy for said user to create a mental picture of a matrix of six elements arranged in rows and columns. Indeed, it is known that ordered groupings of elements of a number not exceeding six are easy to register at first glance. That is the case, for examples, with the values of dominoes.

Moreover, as there are only six groups of four principal letters, instead of the nine or more groups of two or three letters usual on the keypads of the state of the art, and as they are spatially arranged in alphabetical order, it is very easy for the user to remember the position of each of said letters on each key and on the keypad as a whole. Writing is therefore nimble and fast and can be carried out conveniently without looking at the keypad.

Advantageously, said assembly includes means for inverting the spatial arrangement of the characters inscribed on the keys of the rows of said matrix, by rotating the casing in relation to an axis substantially parallel to the ground/floor. Thus, the virtual image of the keypad on the display when the user uses the assembly without looking at the keypad is the same as the image he/she has when looking at it, so that it is always very easy to remember the position and meaning of the keypad characters, whatever the position in which the assembly is used.

Preferably, said assembly includes means for assigning a specific meaning to the simultaneous pressing of at least two of said keys, means for according a specific meaning to at least two successive presses on at least one of said keys, with the time interval between said two pressings being lower than a predetermined value.

Advantageously, said assembly includes means for assigning a specific meaning to a prolonged pressing on at least one of said keys, with the time interval during which said pressing is carried out being greater than a predetermined value.

The potential for entering different characters and functions conveniently and easily with said keypad is thus considerably increased.

According to a second aspect of this invention, it provides a mobile telephone that includes the keypad and display assembly claimed.

Thanks to these characteristics, the dimensions of the telephone casing can be very small, while the size of the display and of the keypad keys can nevertheless be very much greater than those to be found on the mobile telephones of the state of the art. At the same time, the telephone is very convenient and easy to use, since the type of keypad described can be used easily without looking at it. Moreover, the larger display size facilitates the use of Internet browser and electronic mail programs and programs for displaying and editing images, etc., which are cumbersome and slow tasks with the mobile phones of the state of the art.

### BRIEF DESCRIPTION OF THE DRAWINGS

For a better understanding of what has been outlined some drawings are attached which show, schematically and solely by way of non-restrictive example, a practical case of embodiment.

In said drawings,

FIG. 1 is a side view of a preferred embodiment of the casing of the display and keypad assembly of this invention, applicable to a mobile telephone.

FIG. 2 is a view of the upper side of the casing of FIG. 1, which shows the display of the assembly.

FIG. 3 is a view of the lower side of the casing of FIG. 1, showing the keypad of the assembly with six keys actuatable in five directions and on which are inscribed the letters of the alphabet.

FIG. 4 is a view of the lower part of the casing of FIG. 1, showing the keypad of six keys upon which are inscribed the numbers from “0” to “9” that are obtained by actuating said keys.

FIG. 5 is a graphic representation that shows a preferred way of holding the casing of FIG. 1.

### DESCRIPTION OF A PREFERRED EMBODIMENT

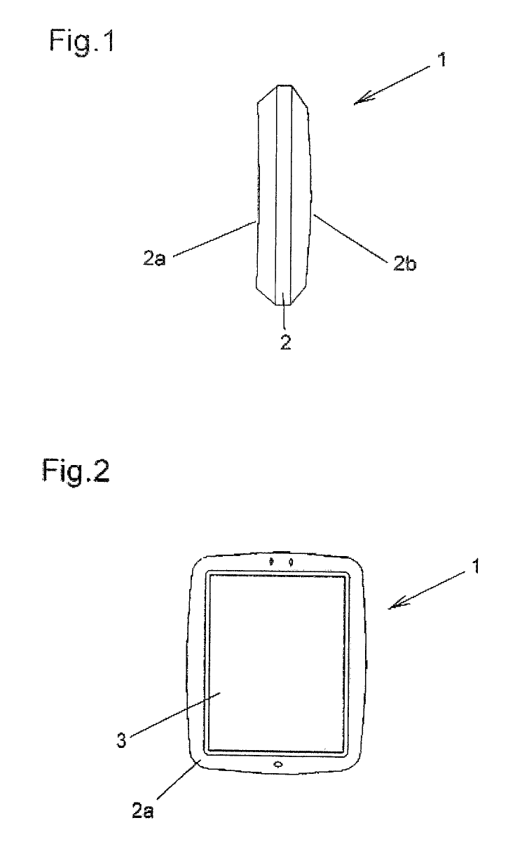

FIG. 1 shows an embodiment of the display and keypad assembly 1 of this invention applicable to mobile telephone, which includes a casing 2 of small dimensions, having an upper side 2a with a display 3 and a lower side 2b with a keypad 4.

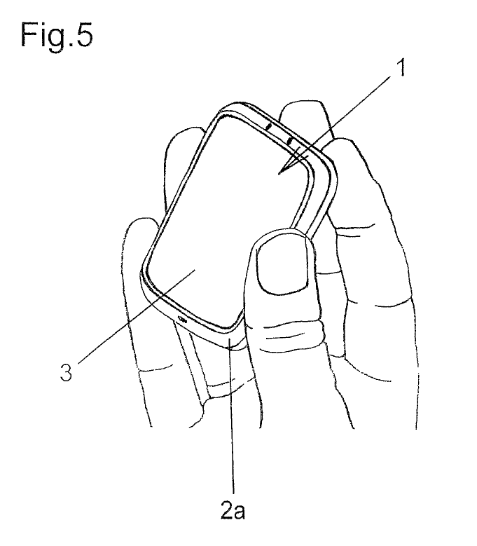

As FIG. 5 shows, said casing 2 can be held with one hand, for example by grasping it by its edges with the thumb, little and ring fingers. The index finger and middle finger are thus left facing the lower side 2b of said casing 2 and free to allow use of the keypad 4 mounted on said lower side, by pressing one key or two keys 4a simultaneously to enter a wide range of different characters 5.

FIG. 2 shows a frontal view of the upper side 2a of said casing 2 on which is mounted the display 3 of the assembly 1, in such a way that the latter occupies the entire surface area of that side 2a.

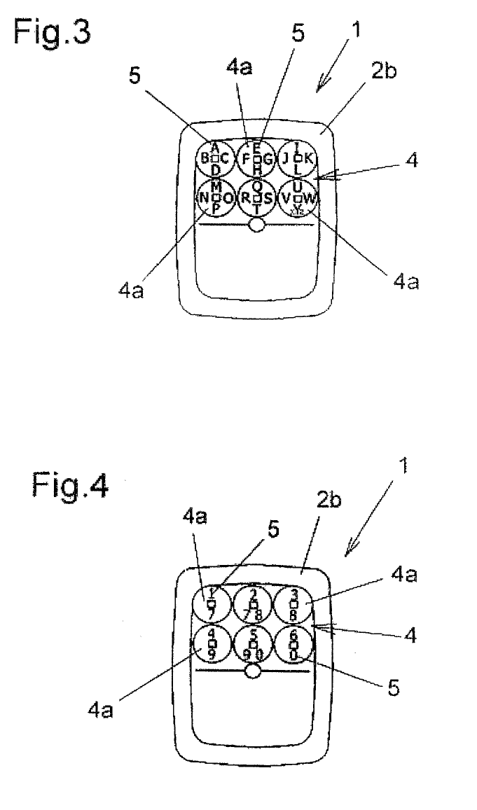

FIG. 3 shows a frontal view of the lower side 2b of the same casing 2, in which is mounted the keypad 4 with six circular-section keys 4a, which are arranged to form a matrix of two rows and three columns.

Each one of the keys 4a can be actuated in five directions by sliding said keys upwards, downwards, towards the right, towards the left and inwards, to provide in each case a different character 5 with a single press or actuation of the corresponding key 4a.

On each of said keys 4a are inscribed four principal letters 5 in four different directions and arranged alphabetically from top to bottom in a highly intuitive manner, as shown in FIG. 3.

The keypad 4 therefore has six groups of four principal letters 5 that add up to a total of twenty-four, which as noted in the description are very easy for the user to remember, since the user can easily create a mental picture of six elements or groups of elements arranged to form a matrix.

The six groups are made up of the following principal letters 5: a first group with the letters “A”, “B”, “C” and “D”; a second group with the letters “E”, “F”, “G” and “H”; a third group with the letters “I”, “J”, 20 “K”, “L”; a fourth group with the letters “M”, “N”, “O”, “P”; a fifth group with the letters “Q”, “R”, “S”, “T” and, finally, a sixth group with the letters “U”, “V”, “W” and “Y”.

However, in order to complete the twenty-six letters 5 of the alphabet, the key 4a of the keypad 4 corresponding to second row, third column of the matrix, which includes the sixth group of principal letters 5, has been designed in such a way that it also presents two additional and infrequently used letters, namely the “X” and the “Z”, situated beside the principal letter “Y”. In this case, in order to obtain said letters 5 “X” and “Z”, the user will have to make two and three successive presses, respectively, on the corresponding key 4a, in the direction of the letter “Y”.

As FIG. 3 shows, in the embodiment described the letters 5 are also arranged alphabetically from top down on the matrix unit that constitutes the keypad 4, in such a way that the three keys 4a of the first row are headed, respectively, by the vowel letters “A”, “E” and “I”, and the three keys 4a of the second row, respectively, by the letters “M”, “Q” and “U”. This spatial arrangement has been chosen due to deeming it easier still for the user to locate the letters 5 on the keypad 4.

FIG. 4 shows the numerical characters 5 “1”, “2”, “3”, “4”, “5”, and “6” that are obtained by pressing, respectively, one single time, the six keys 4a, in the order shown in said FIG. 4. The numbers “7”, “8”, “9” and “0” are obtained by pressing two keys 4a of the keypad 4 simultaneously in the order also shown in FIG. 4. The spatial arrangement of numbers 5 chosen, and the way of obtaining them, is very rational and at the same time intuitive, and is therefore very easy for the user to remember.

In the embodiment described, the display 3 and keypad 4 assembly 1 includes a gravity sensor that allows the spatial arrangement of the characters 5 inscribed on the keys 4a of the rows of the matrix to be inverted by rotating the casing 2 in relation to the ground/floor. Thus, as noted in the description of the invention, when the user uses the assembly without looking at said keypad 4, the virtual image of the keypad 4 on the display 3 is the same as the one the user has when looking at the display.

The display 3 and keypad 4 assembly 1 described is applicable both to mobile telephones and to any other type of small appliance normally used with one hand, such as an electronic diary.

Although not shown, there are eleven combinations of two keys 4a, in addition to those shown for obtaining the numerical characters “7”, “8”, “9” and “0”, and as many again of three or more keys 4a, which can be used, when pressed simultaneously, to obtain additional characters 5 or specific functions required, for example, by a mobile telephone of the type mentioned. Moreover, as all the keys 4a can be actuated in multiple directions, it is possible to program some of them, for example for use as a cursor, by assigning a specific meaning to prolonged pressing of one of said keys 4a.

Surprisingly, the assembly 1 described has the advantage in relation to other assemblies of the state of the art of permitting characters 5 to be obtained on the display 3 without any need to look at the keypad 4, while it is also very convenient and easy to use, since both the size of the keys 4a and of the display 3 is very much larger than it is on the known display and keypad assemblies that are preferably used with one hand.

1. Display (3) and keypad (4) assembly suitable for applying to appliances used with one hand, which includes a substantially planar casing (2), being the display (3) mounted on the upper side (2a) of said casing (2) and the keypad (4) on the lower side (2b) thereof, with said keypad (4) including at least three keys (4a), characterised in that said keypad includes six keys (4a) actuatable in a plurality of directions in order for each of them to enter a plurality of characters (5), said six keys are (4a) arranged in an orderly way into rows and columns to form a matrix on the lower side (2b) of the casing (2), and in that the dimensions of such a casing (2) are such that when the user grassing it by its edges the index finger and middle finger are left free to allow use of said keypad (4).

2. Assembly according to claim 1, characterised in that it includes means for inverting the spatial arrangement of the characters (5) of the rows of said matrix, by rotating the casing (2) in relation to an axis substantially parallel to the ground/floor.

3. Assembly according to claim 1, characterised in that it includes means for assigning a specific meaning to the simultaneous pressing of at least two of said keys (4a) in any of said directions.

4. Assembly according to claim 1, characterised in that it includes means for assigning a specific meaning to at least two successive presses on at least one of said keys (4a), with the time interval between said two pressings being lower than a predetermined value.

5. Assembly according to claim 1, characterised in that it includes means for assigning a specific meaning to a prolonged pressing on at least one of said keys (4a), with the time interval during which said pressing is carried out being greater than a predetermined value.

6. Mobile telephone that includes the keypad (4) and display (3) assembly as claimed in any one of claims 1-7.

7. Assembly according to claim 1, characterised in that each of said keys (4a) is inscribed with a group of numerical and alphabetical characters (5), with said characters (5) arranged spatially on each of said keys (4a) and said groups within the matrix unit, in such a way that they are easy for the user of said appliance to remember.
